(19) United States
(12) Patent Application Publication
(10) Pub. No.: US 2017/0286448 A1
(43) Pub. Date: Oct. 5, 2017

(54) PORTABLE STORAGE DEVICE

(71) Applicant: Hewlett-Packard Development Company, L.P., Houston, TX (US)

(72) Inventor: David H. HANES, Loveland, CO (US)

(21) Appl. No.: 15/506,865

(22) PCT Filed: Aug. 27, 2014
(86) PCT No.: PCT/US2014/052963

§ 371 Date: Feb. 27, 2017

(51) Int. Cl. G06F 17/30

(52) U.S. Cl. CPC G06F 17/30174; G06F 17/30212

(57) ABSTRACT

In one example of the present disclosure, a portable storage device is to obtain a version of the first file from a first computing device and update the first file in the portable storage device to form an updated first file. The portable storage device is then to determine that a version of the first file on a second computing device differs from the updated first file in the portable storage device and provide the updated first file to the second computing device. Furthermore, the portable storage device is to determine that a version of the first file on a remote storage service differs from the updated first file and provide the updated first file to the remote storage service.

### BACKGROUND

A portable storage device is a small storage device meant to store various data types and meant to be easily transportable. For example, a portable storage device may store a user's documents, music, videos, and/or pictures in a form factor that fits within a user's pocket.

The portable storage device is typically capable of coupling with a computing device like a personal computer or smartphone to receive content from the device or to provide content to the device. This coupling may occur via a wired and/or wireless connection, and control may occur via a graphical user interface (GUI) presented on the computing device and/or on the portable storage device.

Depending on the user's particular needs, the portable storage device may be used as a media transport, data repository, or the like. Given the ever-growing need to have instant access to data, it is anticipated that portable storage devices will continue to gain traction in the marketplace to meet this need and to provide user's access to their data irrespective of their location.

### BRIEF DESCRIPTION OF THE DRAWINGS

Examples are described in the following detailed description and in reference to the drawings, in which:

FIG. 1 depicts an example portable storage device in accordance with an implementation of the present disclosure;

FIG. 2 depicts a process flow diagram for example portable storage device operation in accordance with an implementation of the present disclosure;

FIG. 3 depicts a process flow diagram for example portable storage device operation in accordance with another implementation of the present disclosure;

FIG. 4 depicts a process flow diagram for example portable storage device operation in accordance with yet another implementation of the present disclosure; and

FIG. 5 depicts an example portable storage device in accordance with another implementation of the present disclosure.

### NOTATION AND NOMENCLATURE

Certain terms are used throughout the following description and claims to refer to particular system components. As one skilled in the art will appreciate, technology companies may refer to components by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct electrical or mechanical connection, through an indirect electrical or mechanical connection via other devices and connections, through an optical electrical connection, or through a wireless electrical connection.

Additionally, “portable storage device” should be understood to mean a small storage device meant to store various data types (e.g., documents, videos, pictures, and/or music) and meant to be easily transportable. The term “remote storage service” should be understood to mean a “cloud” storage service provider (e.g., Microsoft OneDrive®, Google Drive®, Amazon Cloud Drive®, Apple iCloud®, Dropbox®, and/or Box®). Finally, the term “purge” should be understood to mean deleting data such that it is not recoverable.

### DETAILED DESCRIPTION

As discussed above, portable storage devices are gaining traction in the marketplace due at least to users desire to access data irrespective of their location. Moreover, portable storage devices are gaining traction because storage capacity is increasing while the price for such storage is decreasing. A user therefore can store more data at a reasonable price than was previous possible. Among other things, this has helped increase the acceptance of portable storage devices.

An area, however, where portable storage devices lack robustness is in the areas of synchronization, universality, and security. In particular, there is a lack of an optimized and secure multi-device, multi-OS, rule-based, and profile-based automatic synchronization approach for portable storage devices. Aspects of the present disclosure provide such a solution. In particular, aspects of the present disclosure provide a portable storage device with the capability to automatically and securely synchronize data between different computing devices and/or different cloud storage services while taking into account user profiles and predetermined synchronization rules. These are various other aspects of the solution are described below with reference to various figures and examples.

In particular, in one example, a portable computing device is provided. The portable computing device comprises a storage module, a communications module, and a synchronization module. The storage module is to store a first file, wherein the first file associated with a first user account of a plurality of user accounts. The communications module is to communicate with a first computing device, a second computing device, and a remote storage service, wherein the first computing device executes a first operating system and the second computing device executes a second operating system different from the first operating system. The synchronization module is to (i) determine that a version of the first file on the first computing device has been updated and differs from the first file stored in the storage module, wherein the first file on the first computing device is associated with the first user account of the plurality of user accounts; (ii) obtain the version of the first file from the first computing device and update the first file in the storage module to form an updated first file; (iii) determine that a version of the first file on the second computing device differs from the updated first file in the storage module and provide the updated first file to the second computing device, wherein the first file on the second computing device is associated with the first user account of the plurality of user accounts; and (iv) determine that a version of the first file on the remote storage service differs from the updated first file and provide the updated first file to the remote storage service, wherein the updated first file on the remote storage service is associated with the first user account of the plurality of user accounts.

In another example, a process is provided. The process comprises (i) determining, at a portable storage device, that a version of a first file on a first computing device has been updated and differs from the first file stored on the portable storage device; (ii) obtaining the version of the first file from the first computing device and updating the first file in the portable storage device to form an updated first file; (iii) determining that a version of the first file on a second computing device differs from the updated first file in the portable storage device and providing the updated first file to the second computing device; (iv) determining that a version of the first file on a first remote storage service differs from the updated first file and providing the updated first file to the first remote storage service; and (v) determining that a version of the first file on a second remote storage service differs from the updated first file and providing the updated first file to the second remote storage service.

In yet another example, a non-transitory machine-readable medium is provided. The machine-readable medium comprises instructions, which when executed, cause a portable storage device to (i) determine that a version of a first file on a first computing device has been updated and differs from the first file stored on the portable storage device; (ii) obtain the version of the first file from the first computing device and update the first file in the portable storage device to form an updated first file; (iii) determine that a version of the first file on a second computing device differs from the updated first file in the portable storage device and provide the updated first file to the second computing device; and (iv) determine that a version of the first file on a remote storage service differs from the updated first file and provide the updated first file to the remote storage service.

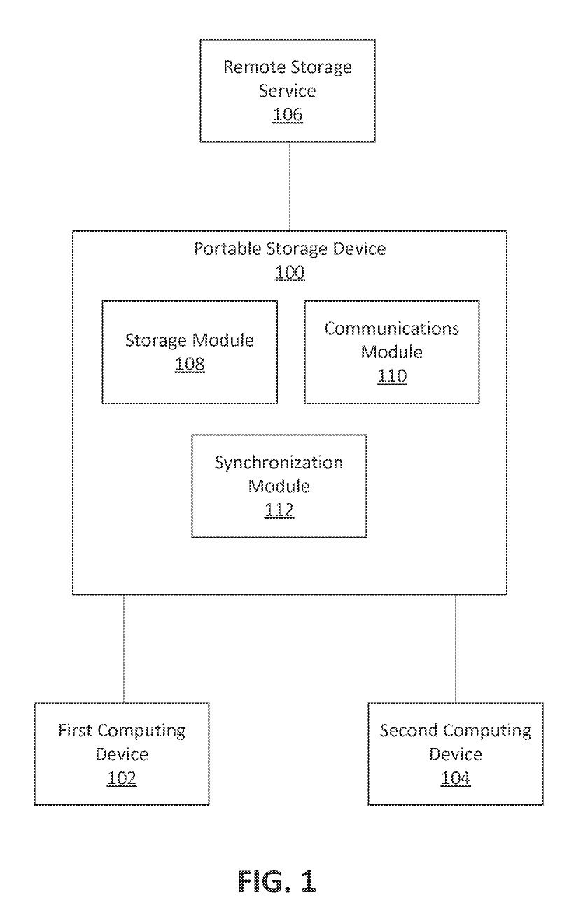

Looking now at FIG. 1, this figure depicts an example portable storage device 100 in accordance with an example. It should be understood that the figure is merely an example in accordance with one implementation, and various devices/modules may be removed, added, or modified in other implementations without departing from the scope of the present disclosure in other implementations.

As shown, the portable storage device 100 is coupled to a first computing device 102, a second computing device 104, and a remote storage service 106. The first computing device 102 and second computing device 104 comprise computing devices like desktops, laptops, tablets, smartphones, workstations, thin clients, smart TVs, servers, gaming devices, retail point of sale devices, and/or other similar computing devices. The remote storage service 106 comprises a “cloud” storage service provider (e.g., Microsoft OneDrive®, Google Drive®, Amazon Cloud Drive®, Apple iCloud®, Dropbox®, and/or Box®). The remote storage service 106, therefore, comprises at least one server and/or storage node configured to offer cloud storage to registered users. The registered users may communicate with the remote storage service 106 via a wide area network (WAN) like the Internet or another type of network (e.g., local area network (LAN), campus area network (CAN), metropolitan area network (MAN), and/or an Intranet) to gain access to the remote storage service 106. Moreover, the registered users may store content like documents, videos, pictures, and music with the remote storage service 106.

Focusing now on the portable storage device 100, this device comprises a storage module 108, a communications module 110, and a synchronization module 112. The storage module 108 is to store data and enable reading and writing of such data. As mentioned, such data may include documents, videos, pictures, music, and/or other forms of data suitable for storage on the portable storage device 100. The storage module 108 stores the data on non-volatile memory. Examples of non-volatile memory include read-only memory (ROM), flash memory, hard disc drives (HDDs), solid state drives (SDD), hybrid drives, optical discs, and non-volatile RAMs like memristor, ferroelectric RAM (F-RAM), magnetoresistive RAM (MRAM).

With regard to the communications module 110, this module enables the portable storage device 100 to conduct wired and/or wireless communication with other devices like the first computing device 102, second computing device 104, and remote storage service 106. The communications module 110 may comprise, for example, a transceiver. PHY, port, modem, and/or antenna. Moreover, the communications module may communicate in accordance with various communication protocols (e.g., TCP/IP, FTP, UDP, and/or IEEE 802.xx). Still further, the communication module 110 may support USB, Ethernet, OTG, and daisy chain connectivity.

Looking now at the synchronization module 112, in one implementation, the synchronization module 112 comprises a processor configured to fetch and execute stored instructions to perform functions discussed herein. In another implementation, the synchronization module 112 comprises a functionally equivalent circuit configured to perform functions discussed herein. Hence, in some implementations, the synchronization module 112 comprises a CPU to execute stored instructions, while in other implementations, the synchronization module 112 comprises an ASIC, FGPA, SoC, microcontroller, circuitry, and/or another component configured to perform functions discussed herein.

Regardless of the implementation, the synchronization module 112 is to perform various functions to synchronize and transfer data between at least the first computing device 102, second computing device 104, and remote storage service 106. As discussed below with reference to various process flow diagrams, this synchronization may by rule-based, profile-based, multi-OS, automatic, multi-device, cloud-enabled, and secure, among other features/functions.

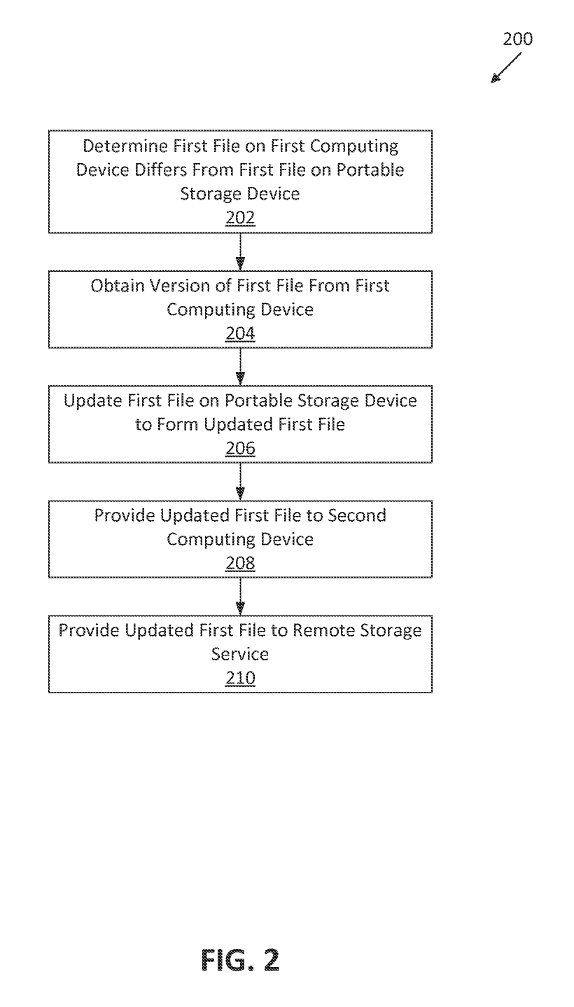

Looking at FIG. 2, this figure depicts a process flow diagram 200 for example portable storage device 100 operation in accordance with an implementation. It should be readily apparent that the processes depicted in FIG. 2 (as well as other process flow diagrams herein) represents generalized illustrations, and that other processes may be added or existing processes may be removed, modified, or rearranged without departing from the scope and spirit of the present disclosure. In addition, it should be understood that the processes depicted may represent instructions stored on a storage medium that, when executed, may cause the portable storage device 100 to respond, to perform actions, to change states, and/or to make decisions. Alternatively or in addition, the processes may represent functions and/or actions performed by functionally equivalent circuits like analog circuits, digital signal processing circuits, application specific integrated circuits (ASICs), or other hardware components that cause the portable storage device 100 to respond, to perform actions, to change states, and/or to make decisions. Furthermore, the flow diagrams are not intended to limit the implementation of the present disclosure, but rather the flow diagrams illustrate functional information that one skilled in the art could use to design/fabricate circuits, generate software, or use a combination of hardware and software to perform the illustrated processes.

The process 200 may begin at block 202, where the portable storage device 100 determines that a first file stored on the first computing device 102 differs from the first file stored on the portable storage device 100. This determination may be accomplished via an automatic and rule-based comparison function, where the portable storage device 100 analyzes various files within a particular folder, drive, and/or partition within the first computing device 102 to determine if the file differs from that stored on the portable storage device 100. This analysis may comprise the portable storage device comparing metadata and/or the file contents to determine if there have been any, e.g., additions, removals, edits, and/or updates. For example, the portable storage device 100 may determine that that document stored on the first computing device 102 has been updated and now differs from the same document stored on the portable storage device 100.

At block 204, the portable storage device 100 obtains the version of the first file from the first computing device 102. This may be accomplished via, for example, a file transfer protocol like SMB, CIFS, Samba, DLNA, AFP, and web-based file upload/download.

Once the version of the first file is obtained from the first computing device 102, at block 206, the portable storage device 100 updates the first file stored on the portable storage device 100 to be form an updated first file. Depending on the implementation, this may comprise replacing the previous version of the first file with the version of the first file from the first computing device 102. Alternatively, this may comprise saving the version of the first file from the first computing device 102 without replacing or otherwise deleting the previous version of the first file. Regardless of the approach, after block 206, the portable storage device 100 includes the updated version of the first file received from the first computing device 102.

At block 208, the portable storage device 100 communicates with the second computing device 104 and determines that a version of the first file on the second computing device 104 differs from the updated first file now in the portable storage device 102. Based on this determination, the portable storage device 100 provides the updated first file to the second computing device 104. Hence, the portable storage device 100, the first computing device 102, and the second computing device 104 now include the same version of the first file (i.e., the updated first file),

At block 210, the portable storage device 100 communicates with the remote storage service 106 and determines that a version of the first file on the remote storage service 106 differs from the updated first file in the portable storage device 102. Based on this determination, the portable storage device 100 provides the updated first file to the remote storage service 106. Consequently, the portable storage device 100, the first computing device 102, the second computing device 104, and the remote storage service 106 now include the same version of the first file (i.e., the updated first file).

As described above, the portable storage device 100 has the capability to communicate with computing devices and storage services, analyze data thereon, and provide updated data to each. As a result, the portable storage device 100 may automatically keep each of a user's computing device (e.g., desktop, laptop, tablet, and smartphone) and storage services (e.g., Google Drive® and Dropbox®) up-to-date with the user's most recent data.

Each of the above discussed computing devices may be situated at different locations, and, in some examples, the updating may occur when the portable storage devices comes within a predetermined distance of the computing device. For example, a user may have a desktop at home and a laptop at work. When the user creates a new document on the home desktop, the portable storage device 100 detects this new document and obtains and stores the document. When the user arrives at work with the portable storage device 100, the portable storage device 100 communicates with the work laptop and determines that the work laptop does not include the new document or includes an earlier version. The portable storage device 100 therefore automatically provides the new document to the work laptop. Thereafter, if the user modifies the document on the work laptop, the portable storage device 100 automatically determines this change and obtains the new document version from the work laptop. Thereafter, when the user arrives home, the portable storage device 100 provides the new document version to the home desktop so each of the portable storage device 100, work laptop, and home desktop include the same version of the document. Moreover, in some implementations, the portable storage device 100 will proceed to provide the new version of the document to at least one remote storage service 106. The portable storage device 100 may access the remote storage service based on previously provided credentials (e.g., username and password). The portable storage device 100 may also access the first computing device 102 and second computing device 104 based on previously-provided credentials.

In addition to computing devices at different locations, the portable storage device 100 is configured to operate with various operating systems (e.g., Android, Chrome, Windows, iOS, and/or Linux). Thus, in some examples, the first computing device 102 executes a first operating system (e.g., Microsoft Windows OS) and the second computing device 104 executes a second operating system different from the first operating system (e.g., Android OS). In addition to different OSs, the computing device may be different types (e.g., laptops, tablets, smartphones, workstations, servers, desktops, and wearable computing devices). For example, the first computing device 102 may be a tablet, while the second computing device 104 may be a workstation.

Additionally, the synchronization of files between the portable storage device 100, first computing device 102, second computing device 104, and remote storage service 106 may be rule-based. In particular, predetermined synchronization rules may be programmed by a user and/or by default to specify rules for synchronization. For example, the synchronization may be limited by computing device ID and/or remote storage service ID. That is, a rule may specify which particular computing device and/or remote storage service should be updated with particular files. Moreover, synchronization may be limited to certain user accounts. That is, when there are a plurality of user accounts (e.g., work account, personal account, parent's account, and/or children's account), a rule may specify how to synchronize files based on the associated user account. Still further, synchronization rules may be limited based on dates and times. For example, the rule may specify particular dates and times when synchronization may occur. Additionally, the synchronization rules may be limited based on specific files, partitions, drives, and/or folders. For example, a user could specify a particular folder on a computing device and/or remote storage service that is to be automatically synchronized, where data outside of that particular folder is not synchronized. Furthermore, with regard to folders, in one example, folders are organized on the portable storage device 100 to enable a user to easily discern the associated computing device and/or user account. More precisely, the portable storage device 100 may include multiple folders where each folder is named based on the device ID (e.g., WorkPC, HomeTablet, HomePC, etc.), remote storage service ID (e.g., GoogleDrive), and/or user account (e.g., Bob, Dad, Mom, etc.) For example, a folder on the portable storage device 100 comprising files from Bob's work desktop may be entitled “WorkPC_Bob” and a folder comprising files from Bob's home laptop may be entitled “HomePC_Bob. Still further, a folder on the portable storage device 100 comprising files from Mom's user account on a tablet may be entitled “HomeTablet_Mom” and files from Dad's user account on the same tablet may be entitled “HomeTablet_Dad.” Such organization may, e.g., help a user promptly find particular files on the portable storage device 100.

With further regard to the synchronization module 112, in some examples, the portable storage device 100 is to cause a status notification to be transmitted to at least the first computing device 102 and/or second computing device 104. In one example, the status notification is directed to the synchronization status. For example, the status notification may indicate which files were previously updated, which files are currently being updated, and/or which files are scheduled to be updated in the future. In another example, the status notification is directed to the battery status. Specifically, the status notification may indicate the status of a battery within the portables storage device 100. This notification may be received by at least the first computing device 102 and/or second computing device 104, and such information may be helpful in determining whether to proceed with future synchronization activities.

In various examples, the portable storage device 100 provides a secure environment for the user. In one example, this security is provided by encrypting the storage module 108 (e.g., encrypting the HDD/SSD), and requiring the user to provide a unique PIN/password to access the data stored in the storage module 108. In another example, security is provided via WiFi broadcast security (e.g., WPA2) that is setup as part of the initial setup of the portable storage device 100. In a further example, data within the storage module 108 is access controlled, and rules may be setup and implemented to control who access what data (e.g., user A can only access data stored in file A; user B can only access data stored in partition B). In yet another example, security is provided by including remote purge capability. In particular, the portable storage device 100 may further comprise a purge module. The purge module may receive a command from a remote device to purge data on the portable storage device and, in response, erase all or a portion of saved data such that the respective data is not recoverable. Among other things, this purge functionality may give a user confidence that, if their portable storage device 100 is lost/stolen, the data may be erased and not accessed by unscrupulous individuals.

In addition to the above, the portable storage device 100 provides remote access capability in various examples. Therefore, if the user leaves the portable storage device 100 at home, the user may still access files on the portable storage device 100 remotely. Moreover, if the user leaves the portable storage device 100 at work, the user may still access the files therein from a remote location even though the portable storage device 100 may be behind a corporate firewall that may require VPN access.

Furthermore, in various implementations, the portable storage device 100 further comprises a network server. In some implementations, the network server is a web server that stores, processes, and delivers web pages. The web server enables the portable storage device 100 to be configured via a web-based interface. Such configuration may comprise providing authentication information for the remote storage service 106, first computing device 102, and/or second computing device 104. For example, the configuration information may be a username and/or password. Depending on the implementation, the web server may be a full-featured web server (e.g., the Apache HTTP server) or a lightweight web server (e.g., LightSpeed or NanoHTTPD). Regardless of the implementation, the web server enables user-friendly configuration of the portable storage device 100 via a web-based interface. It should be understood, however, that the portable storage device 100 is not limited to this type of configuration, and, in some implementations, may be configured via buttons on the portable storage device 100 and/or via a keyboard coupled to the portable storage device 100. Moreover, it should be understood that the present disclosure is not limited to a web server, and other network services or network servers may be utilized to enable user-friendly configuration in accordance with various aspects of the present disclosure. For example, the network server may be a FTP server, DLNA server, or any other network server that utilizes a protocol/mechanism to transfer data between a server and client.

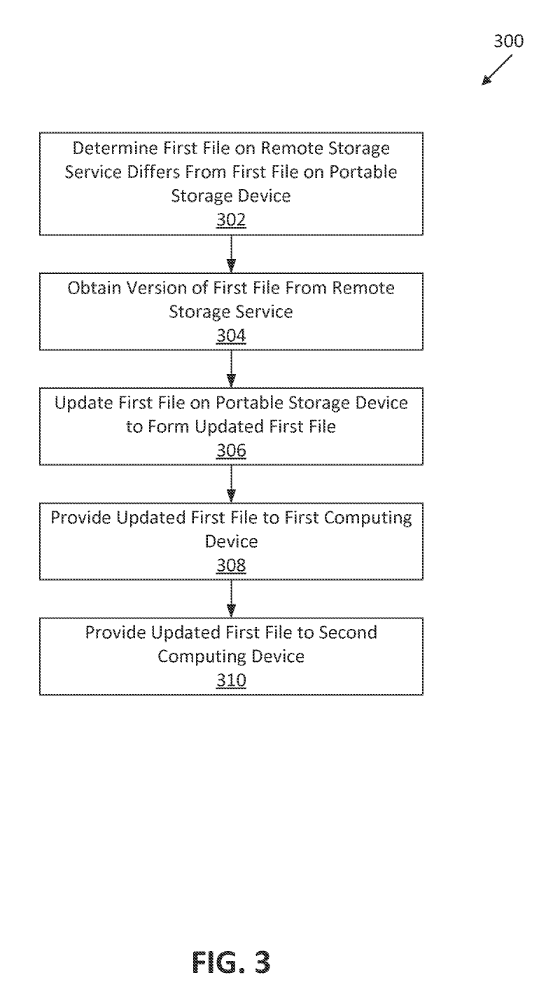

Turning now to FIG. 3, this figure depicts a process flow diagram 300 for example portable storage device 100 operation in accordance with another implementation. In particular, the process is similar to the process discussed with respect to FIG. 2, but in FIG. 3 the process updates files on computing devices in response to changes to files stored in a remote storage service (e.g., Microsoft OneDrive®, Google Drive®, Amazon Cloud Drive®, Apple iCloud®, Dropbox®, and/or Box®).

The process 300 may begin at block 302, where the portable storage device 100 determines that a first file stored on the remote storage service 106 differs from the first file stored on the portable storage device 100. This determination may be accomplished via an automatic and rule-based comparison function, where the portable storage device 100 analyzes various files within a particular folder, drive, and/or partition within the remote storage service 106 to determine if the file differs from that stored on the portable storage device 100. This analysis may comprise the portable storage device comparing metadata and/or the file contents to determine if there have been any, e.g., additions, removals, edits, and/or updates, For example, the portable storage device 100 may determine that that document stored on the remote storage service 106 has been updated and now differs from the same document stored on the portable storage device 100.

At block 304, the portable storage device 100 obtains the version of the first file from the remote storage service 106. This may be accomplished via, for example, a file transfer protocol like SMB, CIFS, Samba, DLNA, AFP, and web-based file upload/download.

Once the version of the first file is obtained from the remote storage service 106, at block 306, the portable storage device 100 updates the first file stored on the portable storage device 100 to form an updated first file. At block 308, the portable storage device 100 communicates with the first computing device 102 and determines that a version of the first file on the first computing device 102 differs from the updated first file now in the portable storage device 102. Based on this determination, the portable storage device 100 provides the updated first file to the first computing device 102. Hence, the portable storage device 100, the first computing device 102, and the remote storage service 106 now include the same version of the first file (i.e., the updated first file).

At block 310, the portable storage device 100 communicates with the second computing device 104 and determines that a version of the first file on the second computing device 104 differs from the updated first file in the portable storage device 100. Based on this determination, the portable storage device 100 provides the updated first file to the second computing device 104. Consequently, the portable storage device 100, the first computing device 102, the second computing device 104, and the remote storage service 106 now include the same version of the first file (i.e., the updated first file).

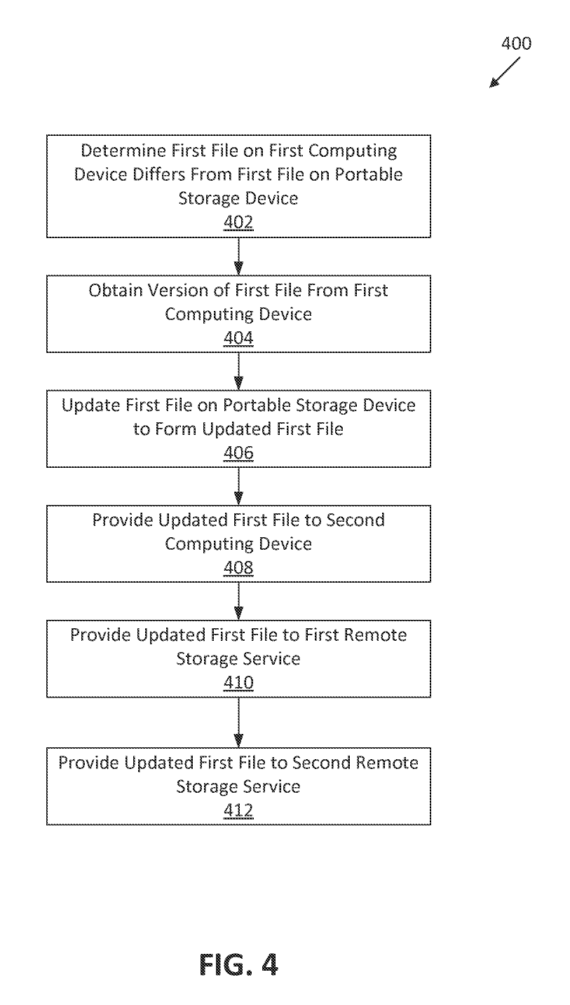

Looking now to FIG. 4, this figure depicts a process flow diagram 400 for example portable storage device 100 operation in accordance with yet another implementation. In particular, the process is similar to the process discussed with respect to FIG. 2, but in FIG. 4 the process updates flies on multiple different remote storage services (e.g., Google Drive® and Dropbox®) in response to detected updates at a computing device.

The process 400 may begin at block 402, where the portable storage device 100 determines that a first file stored on the first computing device 102 differs from the first file stored on the portable storage device 100. At block 404, the portable storage device 100 obtains the version of the first file from the first computing device 102. Once the version of the first file is obtained from the first computing device 102, at block 406, the portable storage device 100 updates the first file stored on the portable storage device 100 to form an updated first file. At block 408, the portable storage device 100 communicates with the second computing device 104 and determines that a version of the first file on the second computing device 104 differs from the updated first file now in the portable storage device 102. Based on this determination, the portable storage device 100 provides the updated first file to the second computing device 104. At block 410, the portable storage device 100 communicates with a first remote storage service (e.g., Google Drive®) and determines that a version of the first file on the first remote storage service differs from the updated first file in the portable storage device 100. Based on this determination, the portable storage device 100 provides the updated first file to the first remote storage service. At block 412, the portable storage device 100 communicates with a second remote storage service (e.g., Dropbox®) and determines that a version of the first file on the second remote storage service differs from the updated first file in the portable storage device 100. Based on this determination, the portable storage device 100 provides the updated first file to the second remote storage service. Consequently, the portable storage device 100, the first computing device 102, the second computing device 104, the first remote storage service, and the second remote storage service include the same version of the first file (i.e., the updated first file).

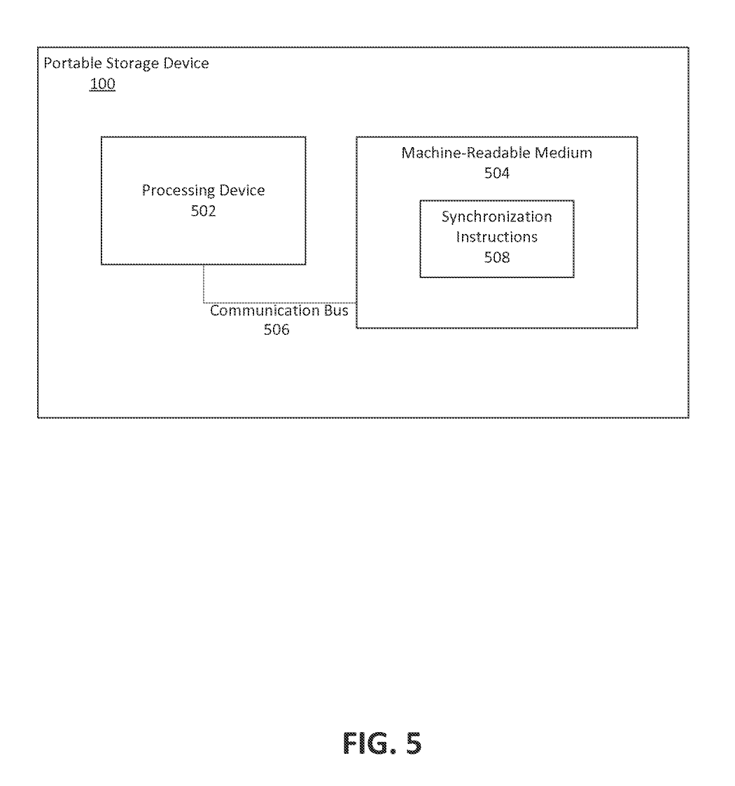

Turning now to FIG. 5, this figure depicts an example portable storage device 100 in accordance with an implementation. The portable storage device 100 comprises a processing device 502 and a non-transitory machine readable medium 504 coupled via a communication bus 506. It should be readily apparent that the portable storage device 100 is a generalized illustration and that other elements may be added or existing elements may be removed, modified, or rearranged without departing from the scope of the present disclosure. For example, the portable storage device 100 may include other components common to a portable storage device 100 such as, for example, a power module, battery, communications module, and the like.

The processing device 502 may be, for example, at least one of a central processing unit (CPU), a semiconductor-based microprocessor, a graphics processing unit (GPU), and/or another processing device arranged to retrieve and execute instructions stored on the machine-readable storage medium 504. Put another way, the processing device 502 may fetch, decode, and execute instructions stored on the machine-readable storage medium 504 to implement the functionalities described above and below.

The machine-readable storage medium 504 may correspond to any typical storage device that stores machine-readable instructions, such as programming code, software, firmware, or the like. For example, the non-transitory machine-readable medium 502 may include one or more of a non-volatile memory, a volatile memory, and/or a storage device. Examples of non-volatile memory include, but are not limited to, electronically erasable programmable read only memory (EEPROM) and flash memory. Examples of volatile memory include, but are not limited to, static random access memory (SRAM) and dynamic random access memory (DRAM). Examples of storage devices include, but are not limited to, hard disk drives, compact disc read/write drives, digital versatile disc drives, optical read/write devices, and flash memory devices.

The machine-readable medium 504 comprises synchronization instructions 508. These instructions 508, when executed by the processing device 502, cause the portable storage device 100 to conduct the various functions discussed herein. For example, in one implementation, the instructions cause the portable storage device 100 to determine that a version of a first file on a first computing device 102 has been updated and differs from the first file stored on the portable storage device 100. The instructions 508 then cause the portable storage device 100 to obtain the version of the first file from the first computing device 102 and update the first file in the portable storage device 100 to form an updated first file. Thereafter, the instructions 508 cause the portable storage device 100 to determine that a version of the first file on a second computing device 104 differs from the updated first file in the portable storage device 100 and provide the updated first file to the second computing device 104. Moreover, the instructions 508 cause the portable storage device 100 to determine that a version of the first file on a remote storage service 106 differs from the updated first file and provide the updated first file to the remote storage service 106.

The foregoing describes a synchronization approach to improve the robustness of portable storage devices. In particular, aspects of the present disclosure provide a portable storage device with the capability to automatically and securely synchronize data between different computing devices and/or different cloud storage services while taking into account user profiles and predetermined synchronization rules, among other functions. While the above has been shown and described with reference to the foregoing examples, it should be understood that other forms, details, and implementations may be made without departing from the spirit and scope of the disclosure that is defined in the following claims.

What is claimed is:

1. A portable storage device, comprising:
a storage module to store a first file, wherein the first file is associated with a first user account of a plurality of user accounts;
a communications module to communicate with a first computing device, a second computing device, and a remote storage service, wherein the first computing device executes a first operating system and the second computing device executes a second operating system different from the first operating system; and
a synchronization module to
determine that a version of the first file on the first computing device has been updated and differs from the first file stored in the storage module, wherein the first file on the first computing device is associated with the first user account of the plurality of user accounts;
obtain the version of the first file from the first computing device and update the first file in the storage module to form an updated first file;
determine that a version of the first file on the second computing device differs from the updated first file in the storage module and provide the updated first file to the second computing device, wherein the first file on the second computing device is associated with the first user account of the plurality of user accounts; and
determine that a version of the first file on the remote storage service differs from the updated first file and provide the updated first file to the remote storage service, wherein the updated first file on the remote storage service is associated with the first user account of the plurality of user accounts.

2. The portable storage device of claim 1, wherein the synchronization module is further to:
determine that the updated first file on the second computing device has been updated to form a second file and the second file differs from the updated first file on the storage device;
obtain the second file from the second computing device and store the second file on the storage module;
determine that the updated first file on the first computing device differs from e second file and provide the second file to the first computing device; and
determine that the updated first file on the remote storage service differs from the second file and provide the second file to the remote storage service.

3. The portable storage device of claim 1, wherein:
the communications module is further to communicate with a second remote storage service; and
the synchronization module is further to determine that a version of the first file on the second remote storage service differs from the updated first file and provide the updated first file to the second remote storage service, wherein the updated first file on the second remote storage service is associated with the first user account of the plurality of user accounts.

4. The portable storage device of claim 1, wherein the synchronization module is further to:
determine that the updated first file on the remote storage service has been updated to form a second file and the second file differs from the updated first file on the storage module;
obtain the second file from the remote storage service and store the second file on the storage module;
determine that the updated first file on the first computing device differs from the second file and provide the second file to the first computing device; and
determine that the updated first file on the second computing device differs from the second file and provide the second file to the second computing device.

5. The portable storage device of claim 1, wherein:
the communications device is further to communicate with a second remote storage service; and
the synchronization module is further to
determine that a version of a second file on the second remote storage device differs from a version of the second file on the remote storage service, and, based on predetermined rules, provide the version of the second file received from the second remote storage service to the remote storage service; and
determine that a version of a third file on the remote storage service differs from the a version of the third file on the second remote storage service, and, based on the predetermined rules, provide the version of the third file received from the remote storage service to the second remote storage service.

6. The portable storage device of claim 1, wherein the portable storage device is to utilize the communications module to transmit a notification to at least one of the first computing device and the second computing device, wherein the notification includes battery status information of the portable storage device.

7. The portable storage device of claim 1, wherein the portable storage device is to utilize the communications module to transmit a notification to at least one of the first computing device and the second computing device, wherein the notification includes synchronization status information.

8. The portable storage device of claim 1, further comprising a purge module to receive a command to purge data on the portable storage device, and, in response, to erase at least the updated first file on portable storage device such that at least the updated first file is not recoverable.

9. The portable storage device of claim 1, wherein the synchronization module is further to check predetermined synchronization rules prior to providing the updated first file to at least one of the first computing device, second computing device, and remote storage service.

10. A method comprising:
determining, at a portable storage device, that a version of a first file on a first computing device has been updated and differs from the first file stored on the portable storage device;
obtaining the version of the first file from the first computing device and updating the first file in the portable storage device to form an updated first file:
determining that a version of the first file on a second computing device differs from the updated first file in the portable storage device and providing the updated first file to the second computing device:
determining that a version of the first file on a first remote storage service differs from the updated first file and providing the updated first file to the first remote storage service; and
determining that a version of the first file on a second remote storage service differs from the updated first file and providing the updated first file to the second remote storage service.

11. The method of claim 10, wherein the first file and updated first file are associated with the first user account of the plurality of user accounts.

12. The method of claim 10, wherein the first computing device executes a first operating system and the second computing device executes a second operating system different from the first operating system.

13. The method of claim 10, further comprising:
checking predetermined synchronization rules prior to providing the first file to at least one of the second computing device, first remote storage service, and second remote storage service.

14. A non-transitory machine-readable medium comprising instructions, which when executed, cause a portable storage device to:
determine that a version of a first file on a first computing device has been updated and differs from the first file stored on the portable storage device;
obtain the version of the first file from the first computing device and update the first file in the portable storage device to form an updated first file;
determine that a version of the first file on a second computing device differs from the updated first file in the portable storage device and provide the updated first file to the second computing device; and
determine that a version of the first file on a remote storage service differs from the updated first file and provide the updated first file to the remote storage service.

15. The non-transitory machine-readable medium of claim 14, comprising further instructions, which when executed, cause the portable storage device to check predetermined synchronization rules prior to determining that the version of the first file on the first computing device has been updated and differs from the first file stored on the portable storage device.
